(19) United States
(12) Patent Application Publication
(10) Pub. No.: US 2007/0155207 A1
(43) Pub. Date: Jul. 5, 2007

(54) REUSABLE WORKER HOUSING AND METHODS RELATING THERETO

(75) Inventor: WADE SPENCER ADAMS, Calgary (CA)

Correspondence Address: BENNETT JONES;C/O MS ROSEANN CALDWELL, 4500 BANKERS HALL EAST, 855 - 2ND STREET, SW, CALGARY, AB, T2P 4K7, CA

(73) Assignee: ATCO STRUCTURES INC., Calgary (CA)

(21) Appl. No.: 11/534,528

(22) Filed: Sep. 22, 2006

(30) Foreign Application Priority Data
Sep. 27, 2005 (CA) 2521352

(51) Int. Cl. H01R 13/44

(52) U.S. Cl. 439/142

(57) ABSTRACT

A worker housing unit for construction of a worker housing complex may include: an under structure, a plurality of walls supported on the under structure including a first end wall, an opposite end wall and a side wall extending between the first end wall and the opposite end wall, an open side opposite the side wall extending between the first end wall and the opposite end wall, the open side formed for securing to another worker housing unit, at least one internal support wall, a plurality of roof trusses supported on the internal support wall and at least one of the plurality of walls, wherein the internal support wall includes a removable wall section, a structural support beam installed above the removable wall section and positioned to support a plurality of roof trusses and a beam support adjacent at least one end of the structural support beam to support the structural support in a spaced relation above the under structure.

### FIELD OF THE INVENTION

This invention relates to worker housing and, in particular, structures and methods relating to constructing and reusing worker housing and worker housing modules.

### BACKGROUND OF THE INVENTION

Worker housing structures are known by many names including bunk houses, workmen dormitories, living containers, man camp accommodation and industrial housing to name a few. Specifically, worker housing structures are accommodations for work persons temporarily housed at a site that has little or no accommodation facilities. The worker housing structures include sleeping and ablution facilities for the work persons. Generally, worker housing is in the form of complexes each complex configured to contain, for example, 60 or more workers on each level. Each complex is formed of several individual manufactured modules joined together. Each module is in turn formed of two worker housing units joined together. The units may be sized to be readily transportable over public roadways, railways or by boat.

The size and configuration of each module and complex is usually determined by the manufacturers of worker housing to provide the most economical solution to the parameters governing worker accommodation for a specific site or project. Consequently, the requirements determining the configuration of worker housing modules and their detailed construction are variables specific to each site at which they will be used, including for example, the natural environment, the terrain, the level of comfort desired for the workmen, the logistics required to get the units and supplies to the work site, the length of the project, the requirements of labor guilds (trade unions), the local Building Codes, and the financial constraints set by the entity responsible for the cost of construction of the total project. Generally, those responsible for, or having jurisdiction over, a specific project will define the site-specific criteria with respect to housing the workforce and the manufacturers of the workers living modules or others having access to previously manufactured worker housing, will offer equipment that meets the site-specific criteria.

Manufactured worker housing modules are sometimes re-used after their initial use to accommodate workers at other construction projects having housing parameters similar to those governing the original one. Usually, the housing modules have to be re-used in their original configuration or with minor modifications to meet minor differences in site conditions, governing bodies or criteria requested by the client responsible for their re-use as worker housing. Manufacturers have concentrated on providing re-use in the same use as the initial use. In particular, to enhance the re-use of manufactured worker housing, the manufacturers of workers living modules and those responsible for the specific projects, have sought to standardize many of the building requirements so that they do not vary significantly from one specific project to the next. Also, manufactures, have at times planned for re-use by considering generalized criteria other than those defined for the initial use to ensure that the worker housing modules may be re-used on projects in other geographical areas and that they will meet site specific criteria or be readily modified to meet special criteria required of the various agencies having jurisdiction in the area of re-use.

The manufacturers usually sell or lease the worker housing equipment for the duration of the specific project. They move the equipment to the specified site, make it operational at the site and provide operational support during the equipment's use. When the equipment is no longer needed, the manufacturers sometimes buy back the equipment and/or move it to a predetermined location, usually a marshaling yard, a significant distance from the project site. Other times, where it is difficult or costly to move the units or the units are so site-specific as to render them of little value for reuse, the worker housing modules may be simply abandoned or discarded. After particularly large projects, many modules may be discarded or abandoned due to oversupply. Many modules may also be discarded or abandoned from projects in remote locations, but are generally of little value due to specific design that limits reuse only as a dormitory for housing numerous persons.

When planning and constructing a worker housing module that is later to be used as a residential structure, consideration should to be given to both the initial industrial use and the future residential use. In the initial use, the structure has to maintain rigid structural integrity that allows it to be moved from a manufacture site sometimes thousands of miles away to a site where it will be used. At the same time, the structure must also allow reconfiguration for reuse as a residential structure.

### SUMMARY OF THE INVENTION

A reusable worker housing structure and methods for building a reusable worker housing structure and for reusing a worker housing structure have been invented.

In accordance with one broad aspect of the present invention, there is provided a worker housing unit for construction of a worker housing complex, the worker housing unit comprising: an under structure, a plurality of walls supported on the under structure including a first end wall, an opposite end wall and a side wall extending between the first end wall and the opposite end wall, an open side opposite the side wall extending between the first end wall and the opposite end wall, the open side formed for securing to another worker housing unit, at least one internal support wall, a plurality of roof trusses supported on the internal support wall and at least one of the plurality of walls, wherein the internal support wall includes a removable wall section, a structural support beam installed above the removable wall section and positioned to support a plurality of roof trusses and a beam support adjacent at least one end of the structural support beam to support the structural support in a spaced relation above the under structure.

In accordance with another broad aspect of the present invention, there is provided a worker housing unit capable of forming a part of a worker housing complex, the worker housing unit comprising: a first end, an opposite end, an elongate side wall extending between the first end and the opposite end, an open side opposite the elongate side wall extending between the first end and the opposite end, the open side formed for securing to another worker housing unit, a roof extending between the first end, the opposite end, the elongate side wall and the open side, a plurality of roof trusses supporting the roof, a structural beam supporting at least a portion of the plurality of roof trusses and supported by a pair of spaced apart support posts, the structural beam positioned to extend from a first position at a first distance from the first end to a second position at a second distance from the first end; an elongate interior wall extending between the first end and the opposite end and spaced from the elongate side wall; a wall section of the elongate interior wall selected to be removed from the elongate interior wall posts to create an enlarged open space in the unit, the wall section extending from substantially the first distance to substantially the second distance and the wall section including a wall sheathing thereon and at least one interior door installed therein.

In accordance with another broad aspect of the present invention, there is provided a worker housing module capable of forming a part of a worker housing complex, the worker housing module comprising: a first end, an opposite end, a first elongate side wall extending between the first end and the opposite end, an opposite elongate side wall extending between the first end and the opposite end, a roof extending between the first end, the opposite end, the first elongate side wall and the opposite elongate side wall; a plurality of roof trusses supporting the roof, a pair of spaced apart elongate walls forming a hallway therebetween, the hallway extending between the first end and the opposite end; a structural beam supporting at least a portion of the plurality of roof trusses and supported by a pair of spaced apart support posts; a wall section positioned below the structural beam and between the pair of spaced apart support posts, the wall section including a wall sheathing thereon and at least one interior door installed therein, the wall section being removable from under the structural beam and from between the pair of spaced apart support posts to create an enlarged open space in the module.

In accordance with another broad aspect of the present invention, there is provided a method for constructing a worker housing unit for use to construct a worker housing complex, the method comprising: planning the construction of an outer frame including a first end, an opposite end, an elongate side wall extending between the first end and the opposite end, the construction leaving an open side opposite the elongate side wall extending between the first end and the opposite end, the open side formed for securing to another worker housing unit; planning the construction of internal walls including a hallway side wall; planning the construction of a plurality of lateral room dividing walls extending between the hallway side wall and the elongate side wall to form at least three bedrooms, considering a second use for the unit including the removal of a portion of the hallway side wall to create an open area and planning the construction of the hallway side wall to include a structural support beam above the portion of the hallway side wall to be removed and at least one support beam adjacent the portion of the hallway side wall to be removed and positioned to support the structural support beam.

In accordance with another broad aspect of the present invention, there is provided a method for reusing a worker complex comprising: providing a worker complex including a first module and an adjacent module arranged in side by side configuration, each module capable of accommodating a plurality of personnel and each module including a hallway side wall, the hallway side wall including a removable wall section, a structural support beam installed above the removable wall section and positioned to support a roof and a beam support adjacent at least one end of the structural support beam to support the structural support; and removing the removable wall section to create an open area.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the figures, wherein:

FIGS. 1A and 1B are floor plan and end elevation views, respectively, of a worker housing complex according to the present invention including units suitable for reuse in at least one secondary application;

FIGS. 2A and 2B are plan views of the framing for a pair of units intended to be brought together to form a worker housing module;

FIGS. 3A and 3B are front elevations of trusses useful in the present invention;

FIG. 4 is a floor plan of a worker housing module constructed using the units of FIGS. 2A and 2B;

FIG. 5 is a floor plan of a residential home obtained from the worker housing module of FIG. 4;

FIG. 6 is a section through a residential house including trusses as shown in FIGS. 3A and 3B. The sectional position may be determined by reference to the position shown as I-I in FIG. 5.

### DESCRIPTION OF VARIOUS EMBODIMENTS

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The invention considers re-use of worker housing in similar, or the same, applications at other sites or other projects as well as parameters governing re-use for alternate secondary purposes usually common to the area of initial use. Alternate secondary uses for manufactured worker housing modules according to the present invention can be, for example, office, commercial, smaller or reconfigured worker housing or residential family housing. For example, secondary uses can include structures having, for example, a combination of sleeping, messing, ablution and/or assembly areas for a population living within the confines of a specific building comprising one or more modules.

In one embodiment, for example, the invention allows for the conversion of a worker housing complex to structures for housing families that may need housing at or may be indigenous to the area of initial use of the complex. The structures can be, for example, configured as conventional detached, semi-detached or attached residential homes. The ability to reuse worker housing as family housing may offer significant economical benefits to the people responsible for the initial project, if the manufactured worker housing modules can be used in this manner in an area at or near the project site, including mitigating the costs of transporting the modules to another project and/or the costs of disposal if re-use is not a viable option and the elimination of idle time before re-use if use in another job site is not readily available.

Some considerations for the planning, construction, and reuse of worker housing complexes are described in applicant's Canadian patent application 2,417,593, filed Jan. 29, 2003.

Worker modules and complexes are formed from worker units. The units may be constructed to be of a size suitable for transport, but are joined together at the job site to form the worker housing modules and complexes.

Where any particular unit is intended to be used in a large worker complex but then reusable in a secondary application, such as a smaller stand alone worker module such as for 10 people or for an attached, a detached or a semidetached house, some consideration may be given at the time of unit construction to facilitate such reuse.

A unit to be assembled into a worker housing complex has to maintain a rigid structural integrity that allows it to be moved from a manufacturing plant to a job site where it will be used. This sometimes requires the unit to be transported thousands of miles. Structural integrity may be provided by the numerous internal walls installed longitudinally and laterally along the unit. Noting that a unit is generally one half of a module, one side of the unit may be open during transport. The internal walls, therefore, also act to support the roof trusses during transport and in the final assembled complex. In a reuse application, however, that same unit may have to be reconfigured to create enlarged open spaces by removing some internal walls. Also, it may further be desired, in some applications, that substantially uniform ceiling heights be provided over the enlarged open spaces. The provision of enlarged open spaces may require the removal of walls that were traditionally used to provide roof support and structural integrity.

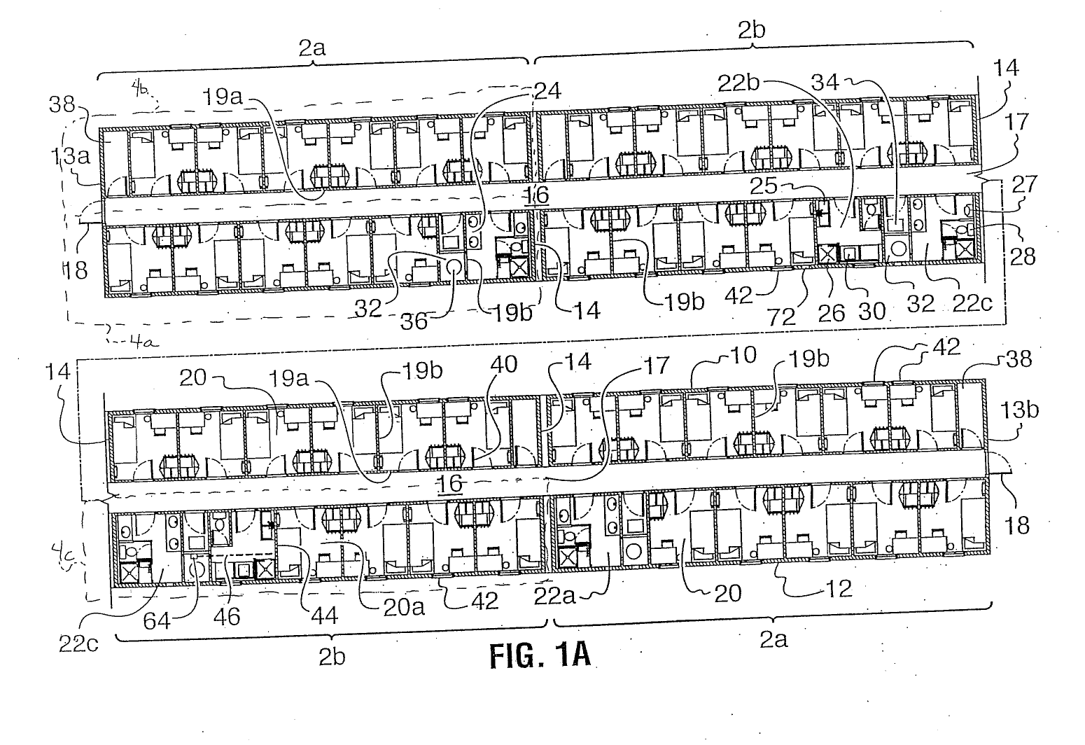

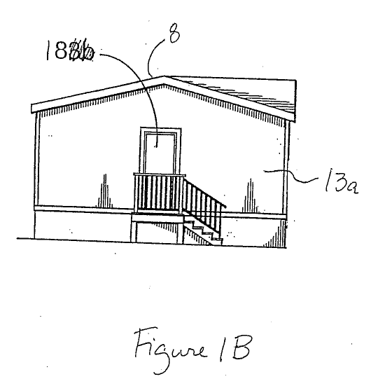

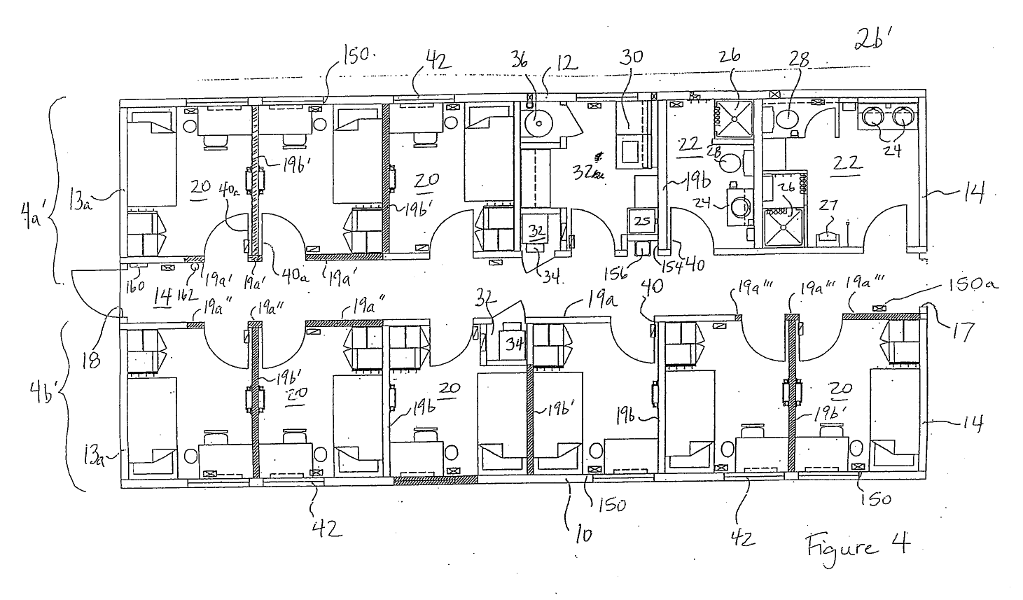

Referring to FIG. 1, there is shown a complex for use in housing at least a portion of a work force. The complex of FIG. 1 is formed of eight units, for example units 4a, 4b, 4c, that together form four modules 2a, 2b joined in end to end configuration. An example of a single module, formed from a pair of units (for example as shown in FIGS. 2A and 2B), is shown in FIG. 4. Units 4a, 4b, 4c can vary depending on the plan for the complex. For example, two units of differing configuration (i.e. one with plumbing and one without, ones with different numbers of bedrooms, etc.) may be connected to form one module and then into an entire complex. Individual units are constructed to include structural components on an under structure, the under structure including, for example, at least some of a configuration of floor joists, floor sheathing and finishing materials.

The complex includes a roof 8 and four exterior facing walls including a first wall 10, an opposite wall 12 and two end walls 13a, 13b. It is noted that because the complex is formed of a plurality of units, each of front, rear and end walls 10, 12, 13a, 13b and the roof are formed by the combination of these structures on the individual units. The roof and exterior facing walls are insulated and clad for exterior exposure. In the illustrated embodiment, each module of the complex may be selected to be separable, in a secondary application, from the other modules of the complex. Thus, the units may have one or more end walls 14 that are not open to the exterior when the modules are assembled in the complex but are insulated and clad for exterior exposure so that the modules can later be separated from the complex and used in a stand alone configuration. The cladding for walls 10, 12, 13a, 13b, 14 and the roof can be of various materials such as of metal sheeting, membrane roofing, etc. It is desirable to select materials rated for safe use, for example with respect to fire ratings, in high density installations such as work camps but consideration may also be given to the acceptance of the cladding materials in secondary applications.

Generally, the interior of a worker housing complex may include a hallway 16 extending through the various modules along the full length of the complex between the end walls 13a, 13b. Openings 17 may be formed in walls 14 and are aligned between the modules to provide open passage between the modules. A plurality of interior walls 19a along each unit form hallway 16 in each module between the openings 17 at each end thereof. An exterior doorway 18 on each end wall 13a, 13b, may provide access to the hallway from outside the complex.

Interior walls 19b may extend substantially laterally along the hallway to define a plurality of rooms in each module. From hallway 16, access may be provided to the plurality of rooms intended to be used by work persons including a plurality of bedrooms 20, of which there are generally more than three in each unit, and washrooms 22 including lavatory sinks 24, mop sinks/laundry tubs 25, showers 26, urinals 27 and toilets 28. Some washrooms may also include clothes washing appliances 30 (i.e. clothes washers and dryers). Rooms 32 may also be provided for enclosing mechanical systems such as furnaces 34 and hot water heaters 26 and for accommodating storage areas, clothes washing appliances 30, etc. Storage rooms and other rooms, such as recreation rooms (not shown) and kitchens (not shown), can also be included in the complex, as desired. The number and size of the rooms in each complex and the purpose of these rooms may be decided based on the various requirements of the job site and requirements set by the entity responsible for the project. In the illustrated embodiment, the complex is selected to house 42 persons, each with their own bedroom 20.

Interior doors 40 are provided where appropriate. A plurality of windows 42 are provided, especially in bedrooms 20 and possibly some washrooms, for ventilation, natural lighting, emergency escape, etc.

Roof 8, for example the trusses thereof, may be supported at least in part on walls 19a. In the illustrated complex, which is intended for reuse as residential housing, the units of the complex may be formed with a truss roof configuration such that when two units are constructed into a module, the overall roof 8 will be peaked (FIG. 1B), thereby, more closely resembling a conventional residential dwelling. Of course, the peaked roof and other exterior decorative features are optional, but can be added to enhance the reuse of modules for family housing. It will be appreciated, however, that in the form of the units intended for use in worker housing, regardless of their end use, it may not be desirable to overly restrict the usefulness, transportability, for example with respect to outer dimensions or weight, or construction.

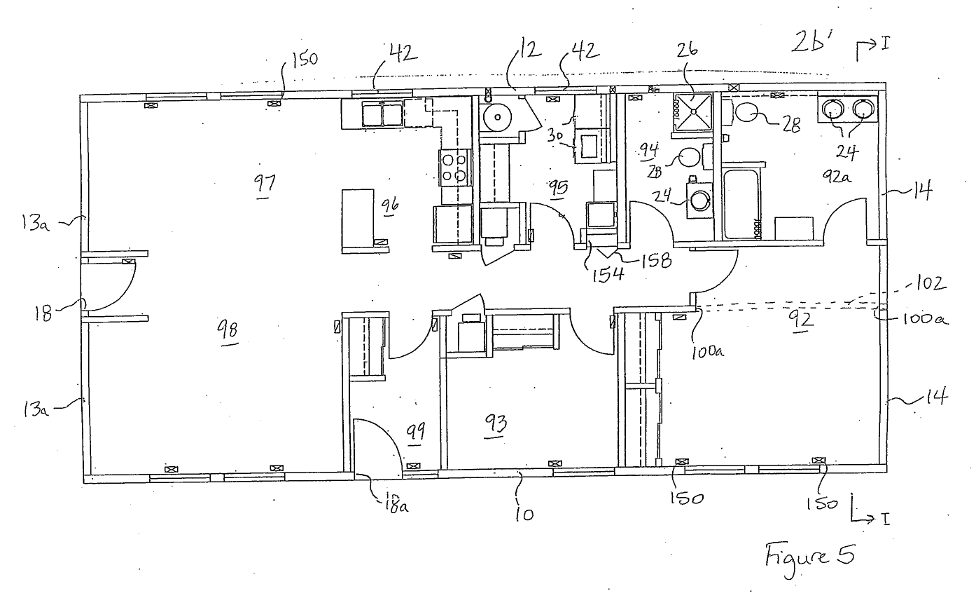

In one illustrated example, a module 2b′ (FIG. 4) from a worker housing complex has been converted into a detached residential family house, shown in FIG. 5. The conversion of a module of a workers housing complex into a residential detached house, may be accomplished with changes to the exterior envelope and changes in the interior arrangements, for example, by removing and/or repositioning walls or portions thereof and/or removing and/or adding fixtures, appliances and equipment. It may be possible to reuse much of the structure and utility distribution system with only minor modification, offering significant economic benefits to the alternative of deploying worker housing to an area to accommodate a construction project, removing it after the construction is completed, and providing separate housing for the families that will service on an ongoing basis the enterprise constructed.

In many conversion projects, interior walls 19a, 19b may be removed to create larger open areas, such as gathering rooms, classrooms, etc. in commercial/institutional/dormitory spaces and living rooms, kitchens, enlarged bedrooms, etc. in residential housing. In so doing, some of the roof supporting walls 19a may be removed. In addition, it may be desired that the enlarged spaces have a substantially uniform ceiling height, for example not including height changes around support beams. Thus, it is desired that structural supports be provided to support the roof trusses while permitting removal of corresponding wall sections therebelow. In one embodiment, the structural supports may be in part integrated to the trusses so that a uniform ceiling height can be provided even at areas spanned by the structural supports.

For example, in the embodiment illustrated in FIGS. 4 and 5, the worker module 2b′ includes a plurality of bedrooms 20 and washrooms 22 and utility rooms 32 for storage, laundry facilities and enclosing some mechanical systems. The worker module may be converted to a family house including a master bedroom 92, an ensuite 92a, a bedroom 93, a bathroom 94, a laundry/utility room 95, a kitchen 96, an eating area 97, a living room 98 and a vestibule 99.

This conversion, for example, included: plugging of wall opening 17; addition of kitchen cabinetry and appliances, an entry door 18a and closets, etc.; removal, replacement and addition of plumbing fixtures, etc.; and removal and repositioning of some lateral walls 19b′ (shown shaded in FIG. 4). In addition, sections 19a′, 19a″ and 19a′″ (shown shaded in FIG. 4) of the module's hallway walls 19a have been removed to form the enlarged spaces for master bedroom 92, eating area 97 and living room 98. Units 4a′, 4b′ may be used to construct the module of FIG. 4 and thereafter the house of FIG. 5. In FIGS. 2A and 2B, roof framing plans are shown for units 4a′, 4b′, which show post 100 and beam 102 structural supports that have been incorporated in hallway walls 19a during construction of the worker housing units, so that adequate structural support for the roof trusses 104 remains after removal of wall sections 19a′, 19a″ and 19a′″.

For example, when planning the units for construction of the worker housing complex from which module 2b′ was obtained, consideration may be given to various project requirements for the worker housing, but consideration may also be given as to the conversion that will be required to render modules or units of the worker housing complex suitable for use in the secondary application. In this case, consideration may be given to the portions of the truss supporting walls that may be removed to create enlarged open spaces and posts 100 and beams 102 may be installed adjacent those areas of removed walls to support trusses 104. In one embodiment, for example, the proposed floor plan for the proposed final secondary application, such as that shown in FIG. 5, may be reviewed first and then a construction plan for the units of the complex may be developed to ensure that the units will accommodate conversion to that secondary application. A support beam and its structural support posts may be positioned in the wall 19a as shown or alternately in other positions corresponding to the length of the wall that is to be removed to create an open space. The beam need only be positioned to support the trusses through an area where load support is needed once an enlarged space is created. As will be appreciated, the most convenient location is along wall 19a, but a beam and its posts could also be positioned with the posts in lateral walls 19b or as stand-alone columns, as desired.

After framing, the units may be completed to a desired state and then shipped to a site for complexing to form a worker housing complex. During shipping, the units may each have an open side 103 which is intended to be connected directly or indirectly to a facing unit to form a module. Connection sites 103a, for example, may be positioned on open side 103, for lining up with and supporting connection directly or indirectly to a facing unit. Connection sites 103a may include, for example, structural members capable of accepting connection of fasteners, brackets, spanning members, etc. Connection sites 103a may be positioned on a facing portion of the understructure, a facing portion of the roof trusses, etc.

In elongate wall 19a, which extends between the ends 13a, 14 of the unit, posts 100 can be installed at or adjacent the ends of a wall section to be removed and can support beam 102 therebetween. The posts and beams can be positioned anywhere in which it is desired to remove a truss supporting wall structure. The wall section to be removed is positioned between posts 100 and below beam 102. Although in the illustrated embodiment, the wall sections 19a′, 19a″ and 19a′″ to be removed include substantially the entire wall area between the posts and below the beams, it is to be understood that less than the entire wall between posts 100 and beams 102 can be removed, if desired. For example a portion of wall can remain between the posts if desired. That remaining portion of wall could, for example, be adjacent to or spaced from one or more of the posts.

As will be appreciated, posts 100 may be constructed to provide adequate structural support to maintain beam 102 and trusses 104 in their intended position in spaced relation above the floor of the unit. Beams 102 may be constructed to provide adequate structural support for trusses 104 and roof supported thereon. Some beam spans in a unit may be shorter than others depending on the size of the enlarged area that is to be formed therebelow. Generally, any beam may have an unsupported length of greater than 4 feet (1.2 m) and supports a plurality of trusses along its length. The posts and the beams for supporting shorter spans may be less rigorous since they need support less weight and stress loads than the beams and posts for longer spans. The posts and the beams may be formed of wood, aluminum, steel, composites, etc., as desired. In one embodiment where the units are framed of wood, posts 100 may, for example, be formed from engineered wood products or single or multiple ply lumber such as a plurality of 2×4's positioned in side by side configuration. Posts 100 may be integrated into reinforced surrounding structural members such that they do not structurally appear as discreet posts. As will be appreciated, for example, a post structure may be integrated into the structure of a unit end wall without the appearance of an actual post. Beams 102 may, for example, be formed from engineered wood products, such as engineered I-beams including for example LSL or other products or single or multiple ply lumber. Trusses 104 can be connected directly to beams 102 if desired so that beams 102 act to hold the trusses in relative position. As such, a beam can replace a standard truss connector string 101 used to hold the trusses in relative position. To facilitate understanding, it is to be noted that generally a beam 102 is intended to provide greater structural load bearing support than either a standard connector 101 or a stud wall top plate.

Posts 100 and beams 102 may be incorporated in various ways in the unit walls in which they are located. For example, in the illustrated embodiment wall sheathing for interior wall finishing may be installed over the posts and beams so that the length of wall 19a in unit, when it is used in worker housing, may be functional to separate the hallway from the lateral rooms. If desired, wall sheathing may cover the posts and beams in a continuous manner such that the locations of posts 100 and beams 102 are not visible. Alternately, the wall sheathing may include seams adjacent the posts and beams. The provision of seams in the wall sheathing may facilitate locating the posts and beams during a structural conversion and may facilitate removal of the wall sheathing in just the wall section to be removed without damaging the wall sheathing in adjacent walls which are not intended to be removed. If seams are provided, it may be beneficial to position the seams along the intersection between the wall section to be removed and that intended to remain in the secondary application. Also, if desired, wall sheathing may be preinstalled on the surfaces of posts 100 and/or beams 102 that aren't visible in the worker housing but are intended to be exposed in a secondary application. For example, in one possible embodiment, surfaces such as post surfaces 100a forming exposed wall ends and wall surfaces in master bedroom 92 can have wall sheathing preinstalled in spite of the fact that these surfaces will not be visible and will serve no purpose in walls 19a of the worker housing complex. However, such prefinishing may facilitate wall preparation in the secondary application after wall sections such as section 19a′″ is removed.

The wall sections 19a′, 19a″ and 19a′″ to be removed may be formed in various ways. For example, the wall sections may be formed to accommodate worker housing requirements such as doors and their frames, closets, emergency lighting, light switches, etc. For example, with reference to the illustrated embodiments, the wall section 19a′ includes two interior doors 40a that are removed to create the enlarged open space for living room 98. Thus, wall sections may be formed to accommodate these structures. It may be desirable to reduce passage of electrical and/or fluid lines (water, gas, ventilation, etc) through the wall section to be removed or to provide quick disconnects for such lines so that handling of such lines is minimized during removal of a wall section. For electrical wiring for example, quick disconnect electrical wiring connectors can be provided in the wire at the interface between a wall that is intended to remain in the second application and a wall section to be removed. Such a disconnect may include releasable lockable male and female electrical connectors. It is to be understood that such considerations for reducing wiring and other lines also may apply to lateral walls, such as walls 19b′, which are preselected to be removed in the secondary application. Quick disconnects may also be useful for such lateral walls 19a′ if wiring therein cannot be avoided.

Wall sections 19a′, 19a″ and 19a′″ to be removed may be constructed using conventional framing with studs or using other construction techniques. Although standard stud spacing may be used, it may be desired to form wall sections in a less rigorous way since the wall sections need not support the trusses 104 but need only support the wall sheathing, doors, etc. However, construction of wall sections may be decided with consideration as to stability during unit transport, worker housing building codes, etc. While the structural members of the wall sections 19a′, 19a″ and 19a′″ may each be connected directly and rigidly to the posts and the beams surrounding them, in some embodiments it may useful to form the wall sections to be very easily removed, as by forming the wall section as a self framed plug with minimal attachment to the posts and/or beams. A self-framed plug may include studs connected between an upper top plate and a lower sole plate, which are connected together in such a way that they can be removed in their connected state, if desired.

The use of posts and beams in the support walls can be used regardless of the form of trusses 104. For example, structural supports may be provided in the walls to support the roof trusses while permitting removal of wall sections therebelow regardless of whether the roof is flat or peaked.

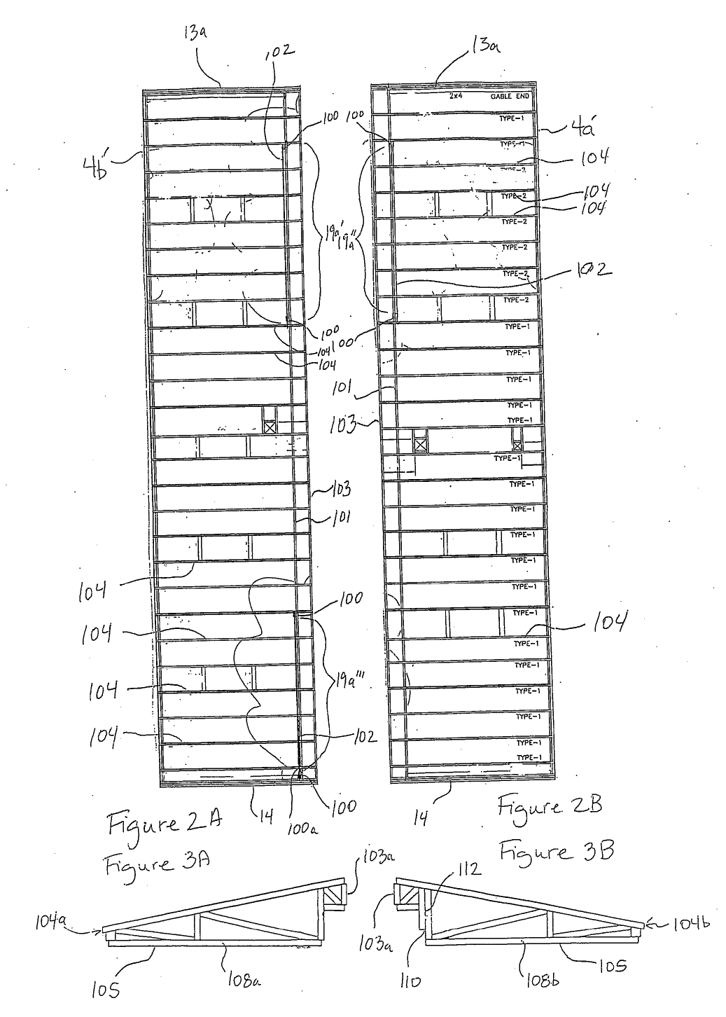

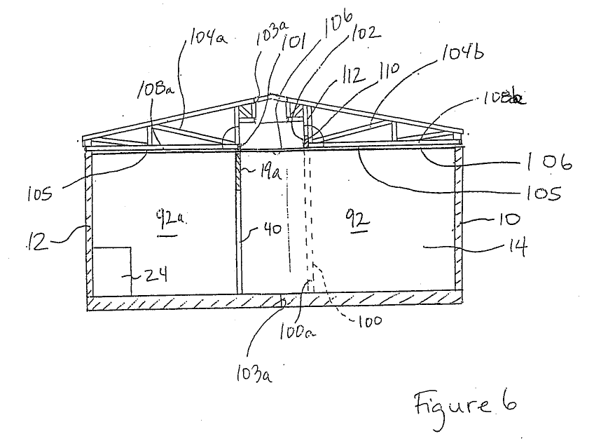

Beams 102 may be installed below trusses 104 to protrude below the plane defined by the lower surfaces of the bottom chords of the trusses (not shown), which may be the plane through which ceiling finishing materials 106 may extend. Alternately, beams 102 may be integrated to trusses such that the beam lower surface 102a becomes substantially flush with or recessed into the plane defined by the lower surfaces 105 of the trusses. By positioning beam 102 in a recessed or flush position with respect to truss surfaces 105, ceiling finishing materials 106 in the secondary application may be installed in a single plane, for example without steps and returns, in enlarged open spaces. To permit installation of beams 102 in this manner, the trusses may be formed to accommodate the beams. For example, with reference to FIGS. 3A, 3B and 6, a truss 104a which is useful over a standard wall 19a includes a bottom chord 108a formed to bear on the unit's exterior wall and interior wall 19a including a plurality of studs and a top plate. A truss 104b may also be provided for installation over wall sections to be removed such as those identified as 19a′, 19a″ and 19a′″. Truss 104b may include a notch 110 along its bottom chord 108b formed to accept the depth of beam 102 therein. In the illustrated embodiment, notch 110 is formed at an intersection between bottom chord 108b and a web member 112 of the truss. The notch is formed to accept beam 102 with its lower surface substantially flush with truss lower surface 105. As such ceiling finishing materials 106 may be connected to truss lower surface 105 and extend over the position of beam 102 in a substantially planar manner without requiring a step down over the beam. Ceiling finishing materials 106 may also be connected directly to the beam if desired. Direct connection of materials 106 may be completed either during unit manufacture or during conversion to a secondary application.

The drawings of the present application may also be reviewed for disclosure of other approaches to facilitate conversion of a worker housing unit to a secondary application. One such aspect is shown for example in FIGS. 4 and 5 with respect to the placement of forced air ventilation ducts 150 throughout the structures. It is noted that conversion from worker housing to a secondary application may be facilitated, if desired, by positioning forced air ventilation ducts in positions to provide ventilation in all necessary rooms of the worker housing but away from walls to be removed such as walls 19b′ and wall sections 19a′, 19a″ and 19a′″. Note that ventilation ducts 150, wherever possible, are positioned adjacent walls that are intended to remain in place in the secondary application. In this way, few vents 150a are positioned away from walls remaining in the secondary application and, therefore, few, if any, vents need be closed off or covered.

Also if desired, at least some of the elements which are necessary for inclusion in worker housing, such as for example recess 154 for drinking water fountain 156, but that are not necessary or desirable for the second application, may be installed in such a way that they may be easily converted for other purposes. For example, recess 154 is formed to accommodate removal of the water fountain and conversion of the area to a storage closet. For example, recess 154 may be formed and adapted to receive a door 158 and/or shelving. In the illustrated embodiment, recess 154 may be formed to have a height greater than a standard drinking water fountain recess, which may be greater than 5½ feet and may be sized to accept a standard height interior door, which may be, for example, approximately 80 inches high. Provision of such a recess facilitates the fitting of a standard door thereover.

In addition or alternately, if desired, wall mounted elements that are necessary in worker housing may be mounted either entirely or with a removable portion protruding on the surface of the wall rather than being recessed therein. Examples of wall mounted elements for worker housing but which may not be desirable to remain in a secondary application may be exit signs 160, emergency lighting, speakers 162, extinguishers, etc. It is desirable that these elements be mounted for removal without causing significant marring of the wall surface, as may be caused by recessed installation of such elements without removable portions thereof. Alternately, such elements may be mounted on wall sections or walls intended to be removed such that the element and all evidence of its mounted configuration may be removed with the wall. Quick disconnects can be used, if desired, to facilitate handling of any element wiring during wall removal.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are know or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

The embodiments of the invention in which an exclusive property or privilege is claimed are defined as follows:

1. A worker housing unit for construction of a worker housing complex, the worker housing unit comprising: an under structure; a plurality of walls supported on the under structure including a first end wall, an opposite end wall and a side wall extending between the first end wall and the opposite end wall; an open side opposite the side wall and extending between the first end wall and the opposite end wall, the open side formed for securing to another worker housing unit; at least one internal support wall; a plurality of roof trusses supported on the internal support wall and at least one of the plurality of walls, wherein the internal support wall includes a removable wall section; a structural support beam installed above the removable wall section and positioned to support at least a portion of the plurality of roof trusses and a beam support post adjacent at least one end of the structural support beam to support the structural support beam in a spaced relation above the under structure.

2. The worker housing unit of claim 1 wherein the removable wall section includes interior wall sheathing thereover.

3. The worker housing unit of claim 1 wherein the removable wall section includes at least a portion of a door frame.

4. The worker housing unit of claim 1 wherein the removable wall section is in a hallway side wall.

5. The worker housing unit of claim 1 wherein a truss from the at least a portion of the plurality of roof trusses includes a bottom chord, a notch in the bottom chord sized to accept the thickness of the structural support beam therein.

6. The worker housing unit of claim 5 wherein the notch and the structural support beam are sized such that a bottom surface of the structural support beam extends no lower than a lower surface of the bottom chord.

7. The worker housing unit of claim 1 further comprising a first electrical conduit in the internal support wall; a second electrical conduit extending into the removable wall section; and an electrical quick disconnection including a socket and an electrical contact prong between the first electrical conduit and the second electrical conduit.

8. The worker housing unit of claim 1 further comprising interior wall sheathing extending over the internal support wall and over the removable wall section, the interior wall sheathing including seams extending along adjacent the structural support beam.

9. The worker housing unit of claim 8 wherein the seams extend along the edges of the removable wall section.

10. The worker housing unit of claim 2 wherein the interior wall sheathing is mounted on a surface of the internal support wall facing the removable wall section, which surface will be exposed after removal of the removable wall section.

11. A worker housing unit capable of forming a part of a worker housing complex, the worker housing unit comprising: a first end, an opposite end, an elongate side wall extending between the first end and the opposite end, an open side opposite the elongate side wall extending between the first end and the opposite end, the open side formed for securing to another worker housing unit, a roof extending between the first end, the opposite end, the elongate side wall and the open side, a plurality of roof trusses supporting the roof, a structural beam supporting at least a portion of the plurality of roof trusses and supported by a pair of spaced apart support posts, the structural beam positioned to extend from a first position at a first distance from the first end to a second position at a second distance from the first end; an elongate interior wall extending between the first end and the opposite end and spaced from the elongate side wall; a wall section of the elongate interior wall selected to be removed from the elongate interior wall posts to create an enlarged open space in the unit, the wall section extending from substantially the first distance to substantially the second distance and the wall section including a wall sheathing thereon and at least one interior door installed therein.

12. A worker housing module capable of forming a part of a worker housing complex, the worker housing module comprising: a first end, an opposite end, a first elongate side wall extending between the first end and the opposite end, an opposite elongate side wall extending between the first end and the opposite end, a roof extending between the first end, the opposite end, the first elongate side wall and the opposite elongate side wall; a plurality of roof trusses supporting the roof, a pair of spaced apart elongate walls forming a hallway therebetween, the hallway extending between the first end and the opposite end; a structural beam supporting at least a portion of the plurality of roof trusses and supported by a pair of spaced apart support posts; a wall section positioned below the structural beam and between the pair of spaced apart support posts, the wall section including a wall sheathing thereon and at least one interior door installed therein, the wall section being removable from under the structural beam and from between the pair of spaced apart support posts to create an enlarged open space in the module, while the at least a portion of the plurality of roof trusses remain supported on the structural beam.

13. The worker housing module of claim 12 wherein the wall section forms part of one of the pair of spaced apart elongate walls forming the hallway.

14. The worker housing module of claim 13 further comprising a second structural beam supporting at least another portion of the plurality of roof trusses, the second structural beam supported by at least one further support post; a second wall section positioned below the second structural beam and being removable and positioned in the other of the pair of spaced apart the elongate walls forming the hallway and opposite the wall section.

15. The worker housing module of claim 12 wherein the enlarged open space comprises a ceiling sheathing support surface including a lower beam surface of the structural beam and a lower truss surface of a truss of at least a portion of the plurality of roof trusses and wherein the lower beam surface and the lower truss surface extend in substantially the same plane.

16. A method for constructing a worker housing unit for use to construct a worker housing complex, the method comprising: planning the construction of an outer frame including a first end, an opposite end, an elongate side wall extending between the first end and the opposite end, the construction leaving an open side opposite the elongate side wall extending between the first end and the opposite end, the open side formed for securing to another worker housing unit; planning the construction of internal walls including a hallway side wall; planning the construction of a plurality of lateral room dividing walls extending between the hallway side wall and the elongate side wall to form at least three bedrooms, considering a second use for the unit including the removal of a portion of the hallway side wall to create an open area; and planning the construction of the hallway side wall to include a structural support beam above the portion of the hallway side wall to be removed and at least one support post adjacent the portion of the hallway side wall to be removed and positioned to support the structural support beam.

17. The method of claim 16 further comprising planning the construction of a roof truss to accommodate the structural support beam such that when the roof truss is supported on the structural support beam, a lower surface of the structural support beam is recessed from or in alignment with a lower surface of a bottom chord of the roof truss.

18. The method of claim 16 wherein in the step of planning the construction of the hallway side wall, the structural support beam and the roof trusses are configured such that after removal of the portion of the hallway side wall to be removed any ceiling sheathing extends substantially in a single plane through the open area under the structural support beam.

19. The method of claim 16 further comprising planning a forced air system with floor vents positioned away from the portion of the hallway sidewall to be removed.

20. The method of claim 16 further comprising planning the installation of wall fixtures intended to be removed in the second use such that they are installed in the portion of the hallway wall to be removed.

21. The method of claim 16 further comprising constructing the worker housing unit.

22. A method for reusing a worker complex comprising: providing a worker complex including a first module and an adjacent module arranged in side by side configuration, each module capable of accommodating a plurality of personnel and each module including a hallway side wall, the hallway side wall including a removable wall section, a structural support beam installed above the removable wall section and positioned to support a roof truss and a beam support post adjacent at least one end of the structural support beam to support the structural support; and removing the removable wall section to create an open area with the roof truss above the open area supported on the structural support beam.

23. The method of claim 22 further comprising installing ceiling sheathing in the open area in a substantially planar expanse extending below the roof truss and extending below the structural support beam.

24. The method of claim 22 wherein the ceiling sheathing is installed without a step being created when passing from a position below the roof truss to a position below the structural support beam.

25. The method of claim 22 further comprising converting a recess for a drinking water fountain into a closet in the hallway side wall.
